(19) United States
(12) Patent Application Publication
(10) Pub. No.: US 2010/0270503 A1
(43) Pub. Date: Oct. 28, 2010

(54) METHOD OF MAKING PHOTOLUMINESCENT SAMARIUM-DOPED TITANIUM DIOXIDE PARTICLES

(75) Inventor: Carmine Torardi, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. Du Pont de Nemours and Company, Wilington, DE (US)

(21) Appl. No.: 12/746,977

(22) PCT Filed: Dec. 22, 2008
(86) PCT No.: PCT/US08/87928

§ 371 Date: Jun. 9, 2010

Related U.S. Application Data
(60) Provisional application No. 61/009,270, filed on Dec. 27, 2007.

(51) Int. Cl. C09K 11/78

(52) U.S. Cl. 252/301.4 R

(57) ABSTRACT

The disclosure provides a process for preparing photoluminescent samarium-doped titanium dioxide, typically in the rutile phase, comprising: precipitating, preferably at a pH of about 2 to about 3, a mixture comprising hydrated titanium oxide, a source of samarium, and a separable filtering agent to form a precipitated mixture comprising precipitated samarium-doped hydrated titanium oxide and the separable filtering agent; filtering the precipitated mixture to form a filter cake comprising the precipitated samarium-doped hydrated titanium oxide and the separable filtering agent; calcining the precipitated samarium-doped hydrated titanium oxide and separable filtering agent at a temperature of greater than about 300° C. to form a mixture comprising samarium-doped titanium dioxide and the separable filtering agent; and removing the separable filtering agent to recover samarium-doped titanium dioxide particles.

### RELATED APPLICATIONS

This application claims the benefit of U.S. Provisional Application No. 61/009,270 filed Dec. 27, 2007 which is incorporated herein by reference in its entirety.

This application is related to Ser. No. 11/800,958 filed on May 8, 2007 which is incorporated herein by reference in its entirety.

### FIELD OF THE DISCLOSURE

This disclosure relates to the preparation of photoluminescent samarium-doped titanium dioxide, and in particular to the preparation of nanocrystalline samarium-doped titanium dioxide which is photoluminescent and which is made using a separable filtering agent.

### BACKGROUND OF THE DISCLOSURE

Titanium dioxide, TiO₂, is often prepared by starting with an aqueous solution of titanium tetrachloride, commonly referred to as titanium oxychloride, and adding a base, such as NaOH or NH₄OH, to produce an amorphous or poorly crystalline hydrated titanium oxyhydroxide precipitate, often called “titanyl hydroxide” or “titanium hydrolysate”, and also form a salt, such as NaCl or NH₄Cl, that mostly dissolves in the aqueous solvent. This is illustrated in the following idealized reaction:

TiOCl₂ (sol'n)+2 NaOH (sol'n)→TiO(OH)₂ (ppt)+2 NaCl (aq, s)

The titanium-containing precipitate can be readily isolated by gravity or vacuum filtration, and, optionally, the precipitate can be washed with water to remove residual metal or ammonium chloride reaction-product salt, and the precipitate can be calcined to convert it into crystalline TiO₂.

The physical properties of the titanium-containing precipitate can vary depending upon the final slurry pH. The precipitate can be thick and composed of relatively large particle agglomerates when the final slurry pH is in the range 5-10. Solid from such a slurry is relatively facile to collect via gravity or vacuum filtration. As the slurry pH is lowered below about 5, the slurry becomes more fluid. Below pH˜3, the solids in the slurry become increasingly more difficult to filter and isolate for further processing. At a pH in the range of about 1-2 or lower, it has been found that the titanium-containing solid, comprising smaller particles, that settles on the filter membrane, compacts and transforms into a gelatinous material that becomes a barrier to liquid flow, resulting in a blocked, or “clogged”, filter.

A need exists for a process for making titanium dioxide particles, and, in particular, nano-sized titanium dioxide particles, that utilizes an acidic slurry that can be easily filtered before calcination to form the final product.

Rare earth doped mesoporous titania thin films which have visible and near-IR luminescence are described in Frindell et al. “Visible and near-IR Luminescence Via Energy Transfer In Rare Earth Doped Mesoporous Titania Thin Films With Nanocrystalline Walls”, Journal of Solid State Chemistry (2003), 172(1), 81-88. The process for making the doped mesoporous titania thin films employs rare earth ions (Sm³⁺, Eu³⁺, Yb³⁺, Nd³⁺, Er³⁺). As noted in the article, the photoluminescent spectra show that europium ions are located in glassy amorphous titania regions near the interface between the anatase nanocrystallites, rather than included as substituted sites in the nanocrystal structure. The sol-gel synthesis method used to make the titania thin films is complex and costly.

The impact on crystal structure of grinding samarium-doped titanium dioxide made by precipitation of titanium dioxide from ammonium hydroxide and titanium tetrachloride is described by Hayakawa, S. et al. in “Structure and the Crystal Field of Samarium-Doped Titanium Dioxide Effects of Formation Conditions and Grinding on the Fluorescence”, Zairyo (1974), 23(250), 531-5. The precipitation method is a less complex and costly process than the sol-gel synthesis described in Frindell et al., but the resulting titanium dioxide product may not be readily dispersible.

In Wang et al., Journal of Molecular Catalysis A: Chemical (2000), 151(1-2), 205-216, “The Preparation, Characterization, Photoelectrochemical and Photocatalytic Properties of Lanthanide Metal-ion-doped TiO₂ Nanoparticles” the photo response of Sm³⁺-doped TiO₂ was described as not being as comparable as that of other lanthanide metal-ion-doped TiO₂, but was said to be a little larger than that of undoped TiO₂. There the TiO₂ nanoparticles are made by a hydrothermal method.

There is a need for a simpler, less costly process for making luminescent titanium dioxide.

### SUMMARY OF THE DISCLOSURE

In a first aspect, the disclosure provides a process for preparing samarium-doped photoluminescent titanium dioxide, and, in particular, rutile titanium dioxide, even more particularly nanocrystalline titanium dioxide comprising:
(a) precipitating, preferably at a pH of about 2 to about 3, a mixture comprising hydrated titanium oxide, a source of samarium, and a separable filtering agent to form a precipitated mixture comprising precipitated samarium-doped hydrated titanium oxide and the separable filtering agent;
(b) filtering the precipitated mixture to form a filter cake comprising the precipitated samarium-doped hydrated titanium oxide and the separable filtering agent;
(c) calcining the precipitated samarium-doped hydrated titanium oxide and separable filtering agent at a temperature of greater than about 300 C to form a mixture comprising samarium-doped titanium dioxide and the separable filtering agent; and
(d) removing the separable filtering agent to recover samarium-doped titanium dioxide particles.

In the first aspect, the mixture comprising hydrated titanium oxide, source of samarium and a separable filtering agent may be prepared by reacting, in the presence of a solvent, titanium tetrachloride or titanium oxychloride and a source of samarium with MOH wherein M is selected from the group consisting of NH₄, and at least one Group 1 metal, and mixtures thereof. The Group 1 metals are listed in Group 1 of the Periodic Table of Elements, Handbook of Physics and Chemistry, 65^{th} Ed., 1984-85. Typically, the solvent is selected from the group consisting of water, water containing at least one metal halide, water containing at least one ammonium halide, a neat alcohol, an alcohol containing at least one metal halide, an alcohol containing at least one ammonium halide, aldehyde, ketone, nitrile, and ether and mixtures thereof. Alcohols are selected from the group of methanol, ethanol, n-propanol, iso-propanol, and butyl alcohol isomer and mixtures thereof.

Some typical Group 1 metals include Na, K, Li and Rb.

### BRIEF DESCRIPTION OF THE FIGURES

FIG. 1 is an X-ray powder diffraction pattern of the calcined material of Example 4.

FIG. 2 is the room temperature emission-excitation spectra of the product of Example 4.

FIG. 3 is the room temperature emission-excitation spectra of the product of Example 5.

### DETAILED DESCRIPTION OF THE DISCLOSURE

In studying the reactions of TiOCl₂ with bases such as MOH (M=NH₄, Li, Na, K, etc.), it was found that by allowing the metal or ammonium chloride salt, that is generated in the reaction, to co-precipitate with the titanium-containing precipitate at low pH values, such as a pH of less than about 3, more typically a pH of less than about 2, and still more typically a pH of about 1 and typically a pH of about 2 to about 3 when a product containing predominantly rutile titanium dioxide is preferred, a filterable solid was produced that did not convert into a gelatinous mass. While not wishing to be bound by theory, the precipitated metal or ammonium chloride salt may serve as a filtering agent that prevented small gel particles from coalescing into larger particles or into a large gelatinous mass. After filtration, the metal or ammonium chloride salt can remain in the isolated precipitate, and the salt may not have to be removed, e.g., by washing with water, before any subsequent calcining process steps. Indeed, water-washing to remove the salt may create conditions for a titanium-containing gel to form, thereby negating the reason for introducing the separable salt filtering agent.

It was additionally found that by including a source of samarium in the reaction mixture a samarium-doped titanium dioxide product can be formed which is photoluminescent.

In step (a) of the process, the mixture comprising hydrated titanium oxide, source of samarium and a separable filtering agent may be prepared by reacting, in the presence of a solvent, titanium tetrachloride or titanium oxychloride and source of samarium with MOH wherein M is selected from NH₄, Group 1 metals or mixtures thereof. The Group 1 metals, also known as alkali metals, are shown in Group 1 of the Periodic Table of Elements, Handbook of Physics and Chemistry, 65^{th} Ed., 1984-85, and mixtures thereof. Some typical Group 1 metals include Na, K, Li and Rb. When M is Li, the resulting LiCl formed from the reaction will most likely be hydrated, i.e., LiCl.H₂O, and will very likely be deliquescent, making it a less desirable filtering aid to use.

The reaction can take place at any temperature between the freezing point and boiling point of the solvent system as long as the solvent provides precipitation of 50 wt. % or more of the reaction-generated NH₄Cl or MCl salt. In the case of using aqueous NH₄Cl saturated at room temperature, for example, at higher temperature, the solution would no longer be saturated and the solution could dissolve more of the filtering agent and this is undesirable. On the other hand, for saturated aqueous NaCl, higher temperatures could be used to react TiOCl₂ and NaOH because the solubility of NaCl in water changes only a little between room temperature and 100° C.

In order to achieve good filtering properties while preventing extended gel formation at pH values of about 2 to about 3, enough of the metal or ammonium chloride salt generated in the reaction must precipitate along with the titanium-containing solid to enable filtration. It is believed that a major portion, typically greater than about 50%, of the metal or ammonium chloride salt generated in the reaction should precipitate with the titanium-containing solid. To precipitate a major fraction of salt, the solvent must have a low capacity to dissolve the reaction-generated salt filtering agent. For an aqueous solvent, a saturated metal or ammonium chloride salt solution may be used. For example, in a reaction of TiOCl₂ with NaOH, the process may employ saturated sodium chloride solution. Alternately, for TiOCl₂ and NH₄OH, saturated aqueous ammonium chloride solution may serve as a starting solvent. The saturated salt starting solutions may become somewhat diluted after adding TiOCl₂ solutions or aqueous base solutions, such as solutions of NaOH or NH₄OH. However, conditions can be easily selected to keep the solvent close to its salt saturation level so that most of the metal or ammonium chloride salt produced from the reaction is forced to precipitate along with the titanium-containing solid. Water may also be used as a suitable solvent. Alcohols are also suitable solvents that would have very low metal or ammonium chloride salt solubility. Some suitable alcohols include, but are not limited to, methanol, ethanol, n-propanol, iso-propanol, or any of one or more of the butyl alcohol isomers. Other solvents such as aldehydes, ketones, nitriles, and ethers, may also be suitable solvents. Mixtures of solvents can also be used.

Typically, the solvent is selected from water containing one or more metal or ammonium halides, neat alcohol, or alcohol containing one or more metal or ammonium halides. Some typical alcohols include ethanol, n-propanol, i-propanol, and one or more isomers of butanol. The alcohols can also contain an ammonium halide or aqueous Group 1 metal halide, or mixture thereof. The separable filtering agent is typically a salt represented by MCl wherein M is selected from NH₄, Group 1 metals from the Periodic Table of Elements, Handbook of Physics and Chemistry, 65^{th} Ed., 1984-85, and mixtures thereof.

The precipitated mixture is then filtered to form a filter cake comprising the precipitated samarium-doped hydrated titanium oxide and a separable filtering agent. This may be accomplished using a vacuum filtering device such as a Pyrex glass filter flask and a filter typically having about 0.2 to about 0.8 μm openings, more typically about 0.45 μm openings. The filter cake may then be dried, typically under an IR lamp and then may be powdered, prior to calcining, using, for example, a mortar.

The filtering step is improved using the process described herein. In contrast to known processes where a gel settles on the filter membrane blocking the flow of liquid from the slurry, the liquid portion of the slurry made in accordance with this disclosure can easily flow through the filter membrane leaving the solid portion behind on the filter membrane in the form of a filter cake. In one embodiment, the filter membrane can be substantially free of filter-blocking gel.

The precipitated samarium-doped hydrated titanium oxide and separable filtering agent may then be calcined at a temperature greater than about 300° C., more typically at a temperature greater than about 400° C., and still more typically at a temperature greater than about 425° C. The upper limit for the calcining temperature is determined by the primary and secondary particle size of the titanium dioxide particles desired. Typically, calcining takes place for a time of about 0.05 hours to about 12 hours, more typically about 1 to about 4 hours. Calcining may be conducted in a tube furnace, box furnace, or other suitable heating device.

After calcining, the metal chloride may be removed by washing with water or a solution comprising water. In the case of NH₄Cl, the salt is removed by sublimation by heating at temperatures greater than about 300° C. Therefore, when a tube furnace is used for the calcining step, sublimed NH₄Cl may be collected at the cool ends of the tube. The metal or ammonium chloride particles, or “spacers”, may also serve to lower agglomeration of the calcined titanium dioxide particles by maintaining a separation, or space, between many of the titanium dioxide particles that could otherwise be in contact and have a tendency to stick together thus making larger agglomerates.

One benefit of conducting the TiOCl₂ reactions at low pH is that after calcining at relatively low temperatures, ca. 300-600° C., a high fraction, greater than about 50%, of the titanium dioxide particles can have the rutile structure. In comparison, similar reactions performed at higher pH values, e.g., pH greater than 3, give a predominance of anatase in the product obtained by calcining in the same temperature range. Low pH reactions, therefore, can provide a means of producing a nanocrystalline and nanoparticulate rutile-rich product. The term “rutile-rich” means a titanium dioxide product which is greater than about 50% rutile, typically greater than about 60% rutile but a higher proportion of rutile may also be present. Thus, the titanium dioxide can be 90% rutile or even higher. The titanium dioxide particles formed have a primary particle size of about 10 nm to about 100 nm, more particularly about 15 nm to about 50 nm. The titanium dioxide primary particles can be agglomerated into larger particles that can be dispersed to provide a particle size distribution (PSD) d₅₀ of less than about 100 nm. The titanium dioxide particles can have a surface area of about 10 to about 90 m²/g.

A samarium-containing compound can be added with the titanium starting material of this disclosure. In one embodiment, the mixture for making the samarium-doped titanium dioxide is formed by contacting the titanium starting material and the source of samarium and adding the resulting mixture to the solvent.

Usually, a minor proportion of the samarium relative to the proportion of titanium and oxygen is suitable to meet the objectives of the disclosure. The mole ratio of titanium to samarium can range from about 1000 to about 1 to about 10 to about 1, typically about 200 to about 1 to about 20 to about 1. Examples of suitable sources of the samarium are selected from the group consisting of, but not limited to, SmCl₃, SmCl₃.6H₂O, Sm(O₂CCH₃)₃.2H₂O, Sm(NO₃)₃.6H₂O, and Sm₂(SO₄)₃.8H₂O and mixtures thereof.

Compositions of matter of this disclosure can be used as a luminescent material. Products, and methods of making them, that can contain luminescent titanium dioxide are well known to those skilled in the art and include plastic films and plastic articles, polymer fibers, pastes, coatings, including paints and the like.

The crystal structure of the titanium dioxide of this disclosure can be substantially in the rutile form and can maintain a rutile crystal phase at temperatures above about 400° C. When samples of the samarium-doped rutile titanium dioxide were heated at about 450° C. and at about 800° C., the products luminesced orange-red. The emission-excitation spectra for products of this disclosure, especially as made in accordance with Examples 4 and 5 hereinbelow, clearly show that samarium is in the rutile structure because the excitation spectra observed, while monitoring emission from samarium, match the absorption spectrum of rutile, i.e., absorption occurs at and in the band gap region of rutile.

It was found that after heating the rutile titanium dioxide product of this disclosure at about 800° the X-ray powder diffraction pattern showed a major proportion of rutile crystals and a minor proportion of anatase crystals. The proportion of anatase can be about 5% or less based on the entire amount of the titanium dioxide sample.

The emission-excitation spectra of the product of this disclosure revealed that samarium is incorporated into the titanium dioxide rutile phase and not only in the anatase phase or separate phase.

The samarium-doped titanium dioxide of this disclosure can be luminescent upon exposure to light in the ultraviolet wavelength at room temperature (temperatures ranging from about 20 to about 25° C.). The samarium-doped titanium dioxide can luminesce orange-red.

The examples which follow, and the description of illustrative and preferred embodiments of the present disclosure are not intended to limit the scope of the disclosure. Various modifications, alternative constructions and equivalents may be employed without departing from the true spirit and scope of the appended claims.

All parts and percentages are by weight unless stated otherwise.

### Examples

### Comparative Example 1

In this example reaction of titanium oxychloride and NH₄OH in water at a pH of about 1 produced a gelatinous material that was difficult to isolate by filtration.

20.0 g (14 mL) of 50 wt. % TiCl₄ in water were added to about 200 mL deionized water with stirring with a Teflon coated magnetic stirring bar in a 400 mL Pyrex beaker. With continued stirring, 24 mL 1:1 NH₄OH solution, made by mixing equal parts by volume of concentrated ammonium hydroxide and deionized water, were added to the titanium-chloride solution to raise the pH to about 1, as measured with multi-color strip pH paper. The resulting white slurry was stirred for about 10 minutes at ambient temperature.

In an attempt to separate the solid from the liquid part of the slurry, the white slurry was transferred to a vacuum filtering vessel having a filter with 0.45 μm openings. The slurry filtered very slowly and only a small amount of material collected on the filter after several hours. The material on the filter eventually converted into a transparent gel that essentially stopped the filtering process.

### Comparative Example 2

In this example reaction of titanium oxychloride and NaOH in water at a pH of about 1 produced a gelatinous material that was difficult to isolate by filtration.

20.0 g (14 mL) of 50 wt. % TiCl₄ in water were added to about 200 mL deionized water with stirring with a Teflon coated magnetic stirring bar in a 400 mL Pyrex beaker. With continued stirring, about 40 mL of 14.4 wt % aqueous NaOH solution were added to the titanium-chloride solution to raise the pH to about 1, as measured with multi-color strip pH paper. The resulting white slurry was refluxed for about 4.5 hrs, then cooled to room temperature.

In an attempt to separate the solid from the liquid part of the slurry, the white slurry was transferred to a vacuum filtering vessel having a filter with 0.45 μm openings. Some white material immediately passed through the filter. The slurry filtered very slowly and only a small amount of material collected on the filter after several hours. The material on the filter eventually converted into a transparent gel that essentially stopped the filtering process.

### Example 1

In this example reaction of titanium oxychloride and NH₄OH in saturated aqueous ammonium chloride solution at a pH of about 1 produced a filterable material that was easily dried to a powder.

About 10.5 mL of concentrated NH₄OH solution were added to 200 mL of saturated aqueous NH₄Cl solution in a 400 mL beaker with stirring using a Teflon coated magnetic stirring bar. 20.0 g (14 mL) of 50 wt. % TiCl₄ in water were added to the NH₄Cl/NH₄OH solution to give a final pH of about 1, as measured with multi-color strip pH paper. The resulting white slurry was stirred for about 1 hr at ambient temperature.

The white slurry comprising hydrated titanium oxide and the separable filtering agent was transferred to a vacuum filtering vessel having a filter with 0.45 μm openings. The slurry was filtered and there was no gel on the filter that was detected. The filter cake was dried under an IR lamp, powdered in a mortar, and calcined in a tube furnace in air by heating to 450° C. over a period of 1 hr, and holding the sample at 450° C. for 1 hr. The sublimed NH₄Cl was collected at the cool ends of the tube. An X-ray powder diffraction pattern of the calcined titanium dioxide product showed the presence of the rutile form of TiO₂ as the major component, ˜85%, and the anatase form as the minor component, ˜15%.

### Example 2

In this example illustrates that reaction of titanium oxychloride and NaOH in saturated aqueous sodium chloride solution at a pH of about 1 produced a filterable material that was easily dried to a powder.

20.0 g (14 mL) of 50 wt. % TiCl₄ in water were added to about 200 mL saturated aqueous NaCl solution with stirring with a Teflon coated magnetic stirring bar in a 400 mL Pyrex beaker. With continued stirring, about 41 mL of 14.0 wt % aqueous NaOH solution were added to the titanium-chloride solution to raise the pH to about 1, as measured with multi-color strip pH paper. The resulting white slurry was stirred for about 10 minutes at ambient temperature.

The white slurry comprising hydrated titanium oxide and the separable filtering agent was transferred to a vacuum filtering vessel having a filter with 0.45 μm openings. The slurry was filtered and there was no gel on the filter that was detected. The filter cake was dried under an IR lamp, powdered in a mortar, and calcined in a box furnace by heating to 450° C. over a period of 1 hr, and holding the sample at 450° C. for 1 hr. Some of the calcined material was washed to remove NaCl by stirring with fresh portions of deionized water until the supernatant conductivity was <100 μS. The washed product was collected by suction filtration and dried in air under an IR lamp. An X-ray powder diffraction pattern of the washed product showed only the presence of the rutile and anatase forms of TiO₂ in roughly equal amounts.

### Example 3

In this example reaction of titanium oxychloride and NH₄OH in n-propanol solution at a pH of about 1 produced a filterable material that was easily dried to a powder.

20.0 g (14 mL) of 50 wt. % TiCl₄ in water were added to about 200 mL n-propanol with stirring with a Teflon coated magnetic stirring bar in a 400 mL Pyrex beaker. With continued stirring, enough concentrated NH₄OH solution was added to achieve a pH of about 1, as measured with multi-color strip pH paper that was pre-moistened with deionized water. The resulting white slurry was stirred for about 1 hr at room temperature.

The white slurry was transferred to a vacuum filtering vessel having a Teflon filter with 0.45 μm openings. The slurry was filtered and there was no gel on the filter that was detected. The filter cake was dried under an IR lamp, powdered in a mortar, and calcined in a tube furnace in air by heating to 450° C. over a period of 1 hr, and held at 450° C. for 1 hr. The sublimed NH₄Cl was collected at the cool ends of the tube. An X-ray powder diffraction pattern of the calcined titanium dioxide product showed only the presence of the rutile and anatase forms of TiO₂ in roughly equal amounts.

### Example 4

A photoluminescent samarium-doped rutile TiO₂ was synthesized from titanium oxychloride and base in a solvent having low solubility for the ammonium chloride generated in the reaction.

0.21 g SmCl₃.6H₂O were dissolved in a few drops of deionized water in a Pyrex beaker. 20.0 g (14 mL) of 50 wt % TiCl₄ in H₂O were added to the samarium solution to give a Ti:Sm molar ratio of 99:1. The samarium-titanium solution was added to a solution consisting of 150 mL isobutyl alcohol and 12 mL concentrated NH₄OH, while stirring with a Teflon coated magnetic stirring bar, to precipitate the titanium and samarium and most of the NH₄Cl formed as a byproduct of the reaction. The pH of the resulting slurry, measured with water-moistened multi-color strip pH paper, was about 2. The resulting slurry was stirred for one hour at ambient temperature.

The solid was collected by suction filtration and dried under an IR heat lamp. The product was powdered in a mortar and then transferred to an alumina boat and heated uncovered in a tube furnace, under flowing air, from room temperature to 450° C. over the period of one hour, and held at 450° C. for an additional hour to ensure removal of the volatile NH₄Cl. Power was removed from the furnace and it was allowed to cool naturally to room temperature.

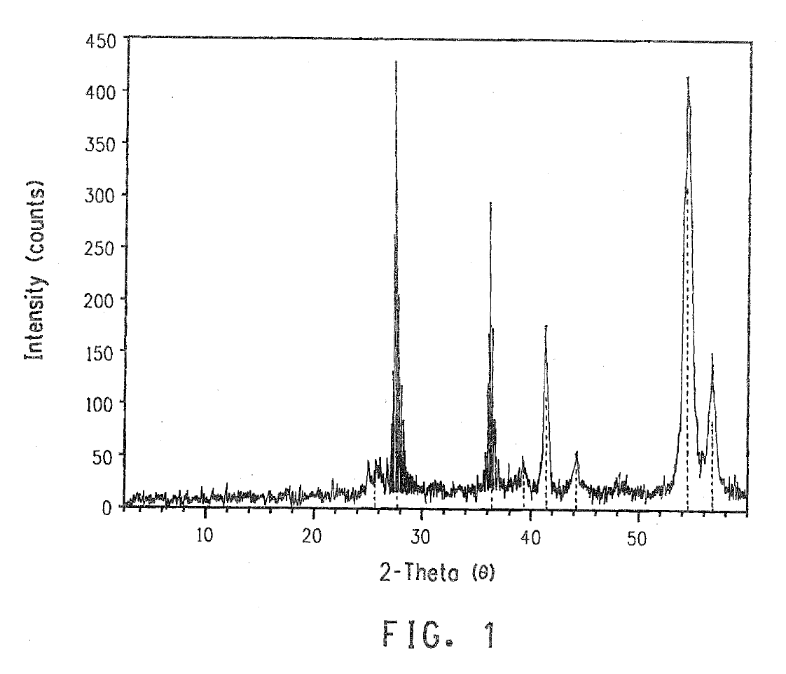

Referring to FIG. 1, an X-ray powder diffraction pattern of the calcined material showed broad lines of rutile and from the width of the strongest peak an average crystal size of 16 nm was estimated. A very small amount of a poorly crystalline anatase form of TiO₂ was also present. From the relative peak heights, the amount of rutile was estimated to be approximately 94%. The fired material luminesced orange-red under a hand-held UV lamp with 254-nm excitation.

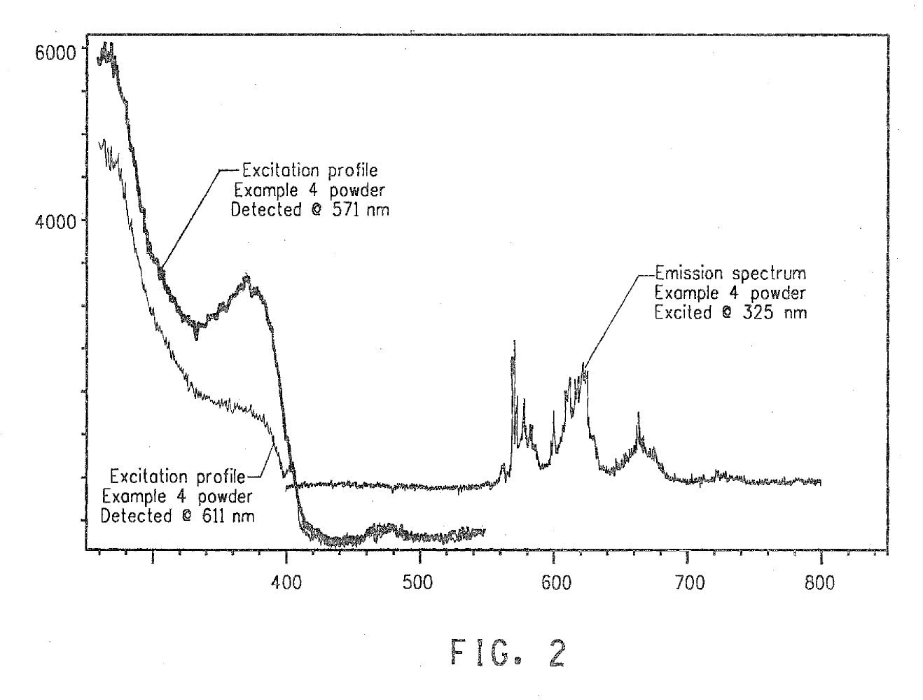

The room temperature emission-excitation spectra for the product of this Example 4 is shown in the Excitation-Emission spectra of FIG. 2.

In FIG. 2, two sets of partially-overlapping samarium emission peaks are seen. One set originates from samarium in the minority anatase phase. The other set is derived from samarium in the majority rutile phase. The results clearly show that samarium is in the rutile structure, and not present only in the anatase phase, or as a separate phase, because the excitation spectrum observed while monitoring emission from the second set of samarium-emission peaks, matches the absorption spectrum of rutile, i.e., absorption occurs in the band gap region of rutile.

### Example 5

The same sample of samarium-doped rutile prepared in Example 4 was heated from room temperature to 800° C. over a two hour period, and held at 800° C. for four hours. An X-ray powder diffraction pattern of the calcined material showed lines of rutile, and from the width of the strongest peak, an average crystal size of 29 nm was estimated. A very small amount of the anatase form of TiO₂ was also present. From the relative peak heights, the amount of rutile was estimated to be approximately 95%. The fired material luminesced orange-red under a hand-held UV lamp with 254-nm excitation.

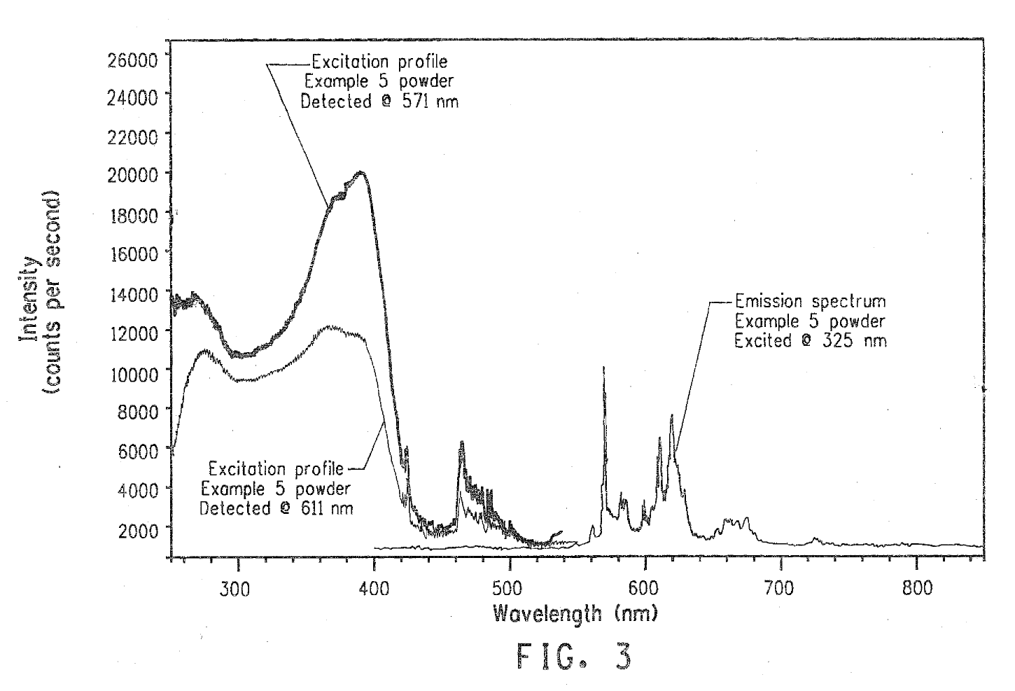

The emission-excitation spectra for the product of this Example 5 is shown in Excitation-Emission FIG. 3. As seen in FIG. 3, two sets of partially-overlapping samarium emission peaks are seen. One set originates from samarium in the minority anatase phase. The other set is derived from samarium in the majority rutile phase. The results clearly show that samarium is in the rutile structure, and not present only in the anatase phase, or as a separate phase, because the excitation spectrum observed while monitoring emission from the second set of samarium-emission peaks, matches the absorption spectrum of rutile, i.e., absorption occurs in the band gap region of rutile.

What is claimed is:

1. A process for preparing photoluminescent samarium-doped titanium dioxide comprising:
(a) precipitating a mixture comprising hydrated titanium oxide, a source of samarium, and a separable filtering agent to form a precipitated mixture comprising precipitated samarium-doped hydrated titanium oxide and the separable filtering agent;
(b) filtering the precipitated mixture to form a filter cake comprising the precipitated samarium-doped hydrated titanium oxide and the separable filtering agent;
(c) calcining the precipitated samarium-doped hydrated titanium oxide and separable filtering agent at a temperature of greater than about 300 C to form a mixture comprising samarium-doped titanium dioxide and the separable filtering agent; and
(d) removing the separable filtering agent to recover samarium-doped titanium dioxide particles.

2. The process of claim 1 wherein the mixture comprising hydrated titanium oxide and the separable filtering agent is prepared by reacting titanium tetrachloride or titanium oxychloride with MOH wherein M is selected from the group consisting of NH₄, Group 1 metal, and mixtures thereof, in the presence of a solvent.

3. The process of claim 2 wherein the Group 1 metal is selected from the group consisting of Na, K, Li and Rb.

4. The process of claim 2 wherein the solvent is selected from the group consisting of water, water containing at least one metal halide, water containing at least one ammonium halide, neat alcohol, alcohol containing at least one metal halide and alcohol containing at least one ammonium halide, aldehyde, ketone, nitrile, and ether and mixtures thereof.

5. The process of claim 4 wherein the alcohol is selected from the group of methanol, ethanol, n-propanol, iso-propanol, and butyl alcohol isomer and mixtures thereof.

6. The process of claim 1 wherein the separable filtering agent is MCl wherein M is selected from the group consisting of NH₄, Group 1 metal, and mixtures thereof.

7. The process of claim 6 wherein the Group 1 metal is selected from the group consisting of Na, K, Li and Rb.

8. The process of claim 2 wherein the precipitating step is carried out at a pH of about 2 to about 3.

9. The process of claim 8 wherein the samarium-doped titanium dioxide particles are predominantly in the rutile phase.

10. The process of claim 1 wherein the calcining temperature is above about 300° C.

11. The process of claim 1 wherein the separable filtering agent is NH₄Cl.

12. The process of claim 1 wherein the separable filtering agent is removed by washing with water or a solution comprising water.

13. The process of claim 1 wherein the samarium-doped titanium dioxide particles are exposed to heat at a temperature up to and including 800° C.
